(19) United States
(12) Patent Application Publication
(10) Pub. No.: US 2021/0369429 A1
(43) Pub. Date: Dec. 2, 2021

(54) DENTAL SUCTION DEVICE UTILIZING HIGH VOLUME EVACUATOR (HVE) LINE

(71) Applicant: SOTA Precision Optics, Inc., Orange, CA (US)

(72) Inventor: Dustin Johnson, Fullerton, CA (US)

(21) Appl. No.: 17/301,449

(22) Filed: Apr. 2, 2021

Related U.S. Application Data
(60) Provisional application No. 62/704,737, filed on May 26, 2020.

(51) Int. Cl. A61C 17/10; A61C 17/08

(52) U.S. Cl. CPC A61C 17/10; A61C 17/08

(57) ABSTRACT

A system and a method for a hands-free dental suction device includes a contoured tube that may be connected to dental suction lines commonly found in dental operatories. One specific embodiment includes features which allow the hands-free suction device to be attached to a dental lip/cheek retractor, and/or to the patient's lip, in a manner that is both comfortable for the patient and allows convenient, unobscured access to the patient's oral cavity. One potential benefit of the device is the collection and removal of dangerous aerosols generated during dental procedures which may be responsible for spreading disease.

### CROSS-REFERENCE TO RELATED APPLICATIONS

This application claims the benefit of provisional patent application No. 62/704,737, filed May 26, 2020, the contents of which are herein incorporated by reference.

### BACKGROUND OF THE INVENTION

### 1. Field of the Invention

Embodiments of the disclosure relate to the fields of dentistry, specifically dental suction devices used for the reduction and removal of aerosols from the air during dental treatment. One specific embodiment of the disclosure relates to the utilization of a suction tube which can be attached to a lip/cheek retractor, and/or to the patient's lip, in a manner that is both comfortable for the patient and allows convenient, unobscured access to the patient's oral cavity.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon. Dental operatories typically contain a fixed chairside or mobile delivery unit, which are host to several dental devices, including but not limited to vacuum lines. Present amongst the common dental vacuum lines is typically one or more high-volume evacuator (HVE) lines, which may be used to connect to suction devices that remove aerosols produced by operations such as ultrasonic dental cleanings and air polishing. Such aerosols are potentially harmful and may include bacteria or viruses that can then propagate through the air and infect dental office staff and patients. Traditionally, HVE lines are connected to very simple straight rigid-tube suction devices that can remove aerosols only in a very specific location and must be manually aimed by the operator. Some devices include additional functionality, such as mirrors. Some devices also offer hands free retraction of the lips or tongue, but typically such devices offer only localized aerosol removal and/or are focused primarily on removal of saliva and water, and not aerosols.

Currently, there are no widely used aerosol removal solutions that attach to an

HVE vacuum line and rest outside of the mouth or near the oral cavity. Such solutions may offer better protection to dental practitioners over intraoral solutions, especially in instances where aerosol generation is directed up and out of the mouth. Existing solutions are not widely used typically because practitioners are inconvenienced by the need to use a lip/cheek retractor, because the device may only be attached to a lip/cheek retractor in one position, or because the device obscures the oral cavity in a manner that is not conducive to treatment.

### SUMMARY OF THE INVENTION

In an embodiments of the present invention a hands-free dental suction device capable of removing potentially harmful aerosols generated by dental procedures is described.

Embodiments of the present invention provide a hands-free dental suction device comprising a suction body extending from a distal end to a proximal end thereof; a lip attachment feature disposed on one side of the suction body adjacent the proximal end; and a lip/cheek retractor attachment feature disposed on one side of the suction body.

Embodiments of the present invention further provide a hands-free dental suction device comprising a suction body extending from a distal end to a proximal end thereof; a suction opening formed at the proximal end; a suction tube connection point at the distal end; a lip attachment feature disposed on a back side of the suction body adjacent the proximal end; and a lip/cheek retractor attachment feature disposed on the back side of the suction body, wherein the lip/cheek retractor attachment feature provides a path for a lip/cheek retractor to extend therethrough that is oriented approximately normal to the suction body.

Embodiments of the present invention also provide a hands-free dental suction device comprising a suction body extending from a distal end to a proximal end thereof; a suction opening formed at the proximal end; a suction tube connection point at the distal end; a lip attachment feature disposed on a back side of the suction body adjacent the proximal end; and a lip/cheek retractor attachment feature disposed on the back side of the suction body, wherein the suction body includes a first portion extending between the proximal end to a first bend in the suction body and a second bend in the suction body prior to the distal end thereof.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 illustrates one embodiment of a hands-free HVE suction device including a lip attachment feature 101, a universal lip/cheek retractor attachment feature 102, a volume optimized suction opening (wide mouth) 103 and an HVE valve and/or other vacuum tube connection point 104;

FIG. 2 illustrates one embodiment of a hands-free HVE suction device including a lip attachment feature 201, a universal lip/cheek retractor attachment feature 202, a pressure optimized suction opening (straight mouth) 203 and an HVE valve and/or other vacuum tube connection point 204;

FIG. 3 illustrates one embodiment of a hands-free HVE suction device affixed to a commonly available lip retraction device 301 using a universal lip/cheek retractor attachment feature 302;

FIG. 4 illustrates one embodiment of a hands-free HVE suction device 401 with the lip attachment feature 402 attached to the lip of a patient 404 and the vacuum tube connection point attached to a standard HVE valve 403; and

FIG. 5 illustrates one embodiment of a hands-free HVE suction device 501 in use, attached to a standard HVE valve 502 and an alternate position on the lip of a patient 503.

Unless otherwise indicated illustrations in the figures are not necessarily drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In the following description, for purposes of explanation, numerous specific details are set forth in order to provide a thorough understanding of the present invention. It will be evident, however, to one skilled in the art that the present invention may be practiced without these specific details. The present disclosure is to be considered as an exemplification of the invention and is not intended to limit the invention to the specific embodiments illustrated by the figures or description below.

As is well known to those skilled in the art, many careful considerations and compromises typically must be made when designing for the optimal configuration of a commercial implementation of any system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Broadly, embodiments of the present invention provide system and a method for a hands-free dental suction device. The system includes a contoured tube that may be connected to dental suction lines commonly found in dental operatories. One specific embodiment of the disclosure includes features which allow the hands-free suction device to be attached to a dental lip/cheek retractor, and/or to the patient's lip, in a manner that is both comfortable for the patient and allows convenient, unobscured access to the patient's oral cavity. One potential benefit of the device is the collection and removal of dangerous aerosols generated during dental procedures which may be responsible for spreading disease.

Embodiments of a hands-free dental suction device utilizing a high-volume evacuator (HVE) line or other dental vacuum line are described. In one embodiment of the hands-free dental suction device, the device is produced with a lip attachment feature in a hook shape that can comfortably be attached to a patient's lip or the side of a patient's lip.

In one embodiment of the hands-free dental suction device, the device is produced with an attachment feature for use with a lip/cheek retractor or other device that may be used to hold the hands-free suction device stable during use. In this embodiment the single attachment point to the lip/cheek retractor allows the operator the ability to position the device in a variety of positions on the lip/cheek retractor. In one embodiment of the hands-free dental suction device, both the lip attachment feature and the lip/cheek retractor feature may or may not be used simultaneously.

In one embodiment of the hands-free dental suction device, the device may be expanded by attachments that add additional functionality, for example but not limited to a hood attachment that may widen the opening to allow for greater area of coverage that may be connected near or at the distal end of the device, or a light emitting diode (LED) array that may allow for illumination of the oral cavity during use and may be connected to either the distal end of the device or an attachment point on the device body.

In one embodiment of the hands-free dental suction device, the tube connection point that is used to connect the device to a vacuum line may be adapted for larger or smaller vacuum lines or valves through the use of removable attachment mechanisms.

In one embodiment of the hands-free dental suction device, the device integrates light emitting diodes or other light emitting devices into the suction end of the device to facilitate illumination of the oral cavity during use.

In one embodiment of the hands-free dental suction device, the device is reduced in size for the benefit of enhanced comfort in smaller patients, such as children, or to facilitate compatibility with smaller lip/cheek retractors.

In one embodiment of the hands-free dental suction device, the device includes a flared, wide mouth suction opening to create a higher volume of airflow towards the device.

In one embodiment of the hands-free dental suction device, the device includes a straight, narrow suction opening to create a limited region of highly localized pressure, allowing for use with smaller patients and also to better collect high velocity aerosols as they leave the mouth.

In one embodiment of the hands-free dental suction device, the device may use both a centrally located lip/cheek retractor attachment feature in combination with additional attachment features located laterally with respect to the edges of the device.

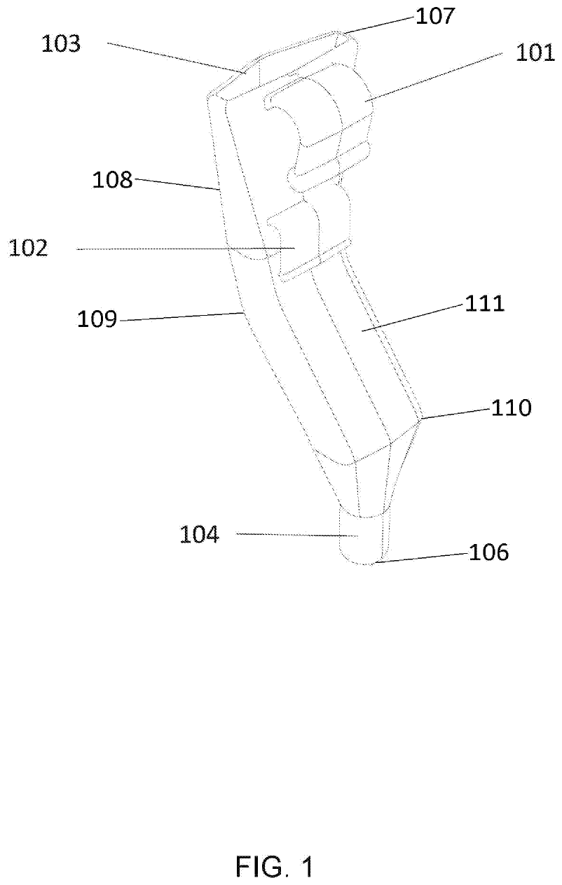

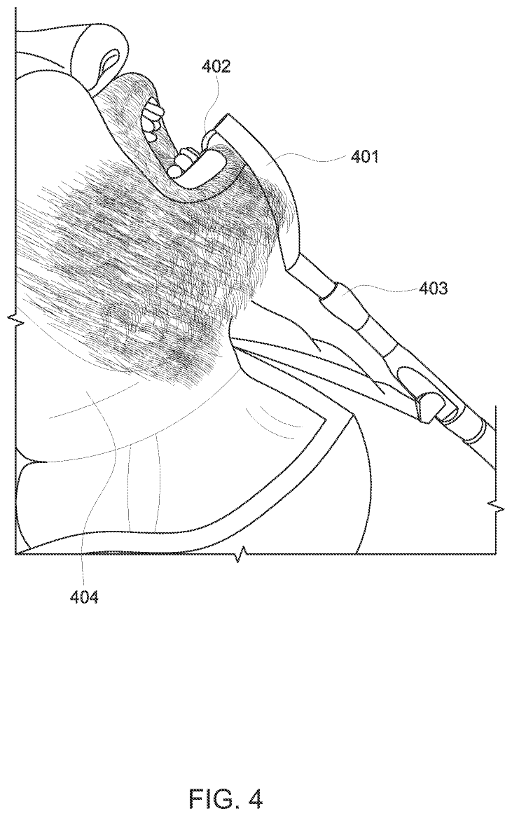

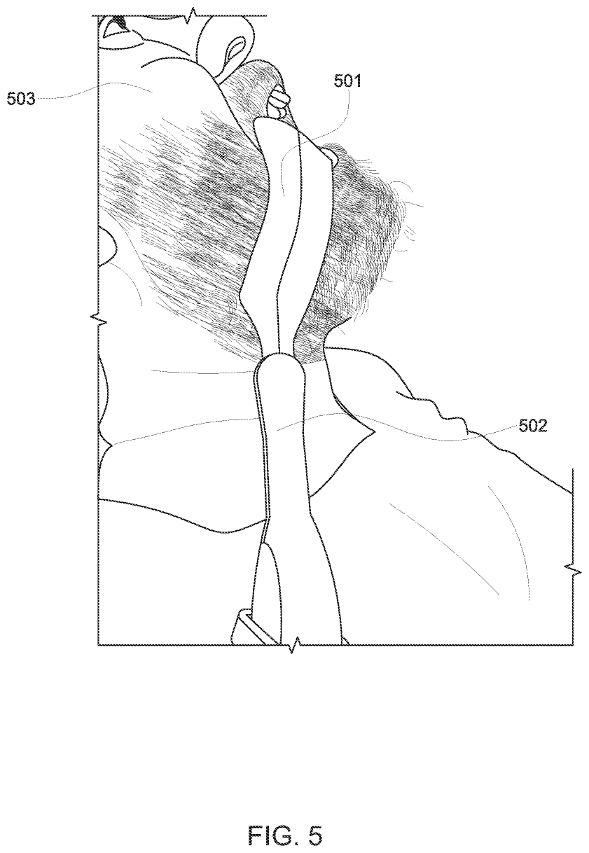

Referring now to FIG. 1, a hands-free HVE suction device can include a suction body 105 extending between a distal end 106 to a proximal end 107. The suction body 105 can be a hollow tubular structure extending from an HVE valve and/or vacuum tube connection point 104 at the distal end 106, to a suction opening 103 at the proximal end 107. The suction body 105 can include a first section 108 extending from the suction opening 103, with a first bend 109 followed by a second bend 110 before reaching the distal end 106. The first bend 109 may bend the suction body 105 toward a patient (see FIGS. 4 and 5), while the second bend 110 may be in an opposite direction. In some embodiments, the first bend 109 and the second bend 110 may result in a portion of the suction body 105 from the second bend 110 to the distal end 106 to be generally parallel to the first section 108. In other words, the bends 109, 110 may result in a jog in the length of the suction body 105. Of course, other geometries for the suction body 105 may be used within the scope of the present invention, including linear, arced, or the like.

A lip attachment feature 101 can be disposed on a back side 111 of the suction body 105. The lip attachment feature 101 may form a hook-like structure open toward the distal end 106 of the device. The lip attachment feature 101 may be sized to permit the device to be hooked on a lip or cheek of a user as shown in FIGS. 4 and 5. In some embodiments, the lip attachment feature 101 may be formed from a flexible or semi-flexible material. In some embodiments, the lip attachment feature 101 can flex to open and provide slight pressure on the patient's lip—enough pressure to hold the device in place, but not enough to be of discomfort to the patient, for example.

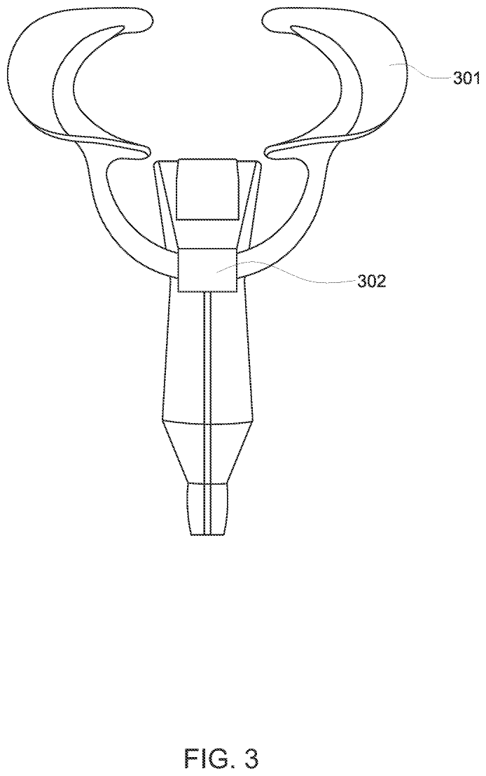

A lip/cheek retractor attachment feature 102 may be included to connect a lip/cheek retractor thereto, as illustrated in FIG. 3, which shows a hands-free HVE suction device affixed to a commonly available lip retraction device 301 using a universal lip/cheek retractor attachment feature 302, which is similar or the same as the lip/cheek retractor 101 of FIG. 1. In some embodiments, a plurality of the lip/cheek retractor attachment feature 102 may be disposed along a length of the suction body 105, providing different attachment locations for the lip retraction device 301.

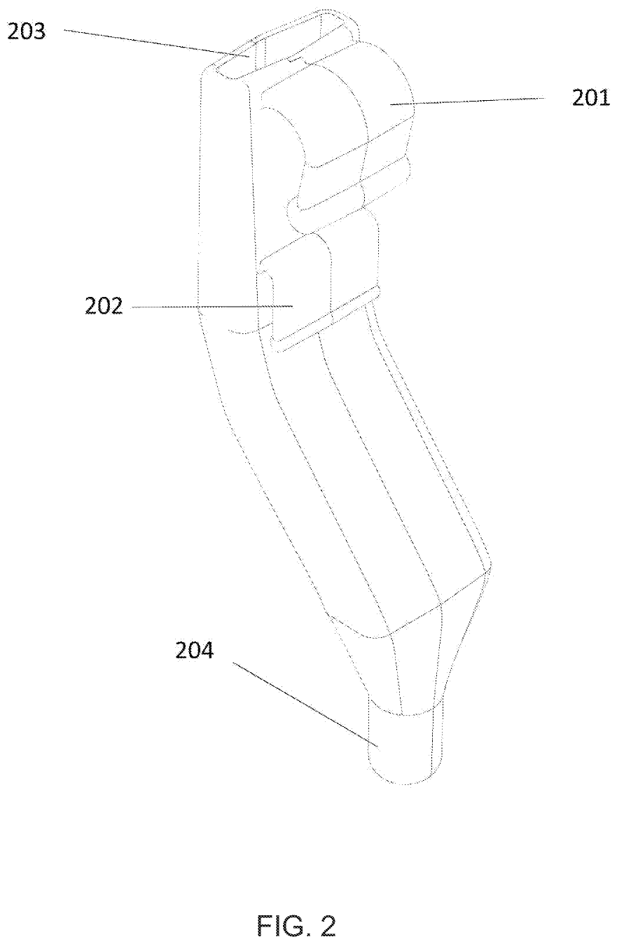

The embodiment of FIG. 1 has a wide mouth suction opinion 103. The suction opening 103 may vary in size in shape, as discussed above. For example, referring to FIG. 2, a hands-free HVE suction device includes a lip attachment feature 201, a universal lip/cheek retractor attachment feature 202, and an HVE valve and/or other vacuum tube connection point 204, similar to that of FIG. 1, described above. In FIG. 2, the suction opening 203 is a pressure optimized suction opening with a straight mouth to provide a greater suction velocity as compared to the suction opening 103 in FIG. 1. FIG. 4 illustrates one embodiment of a hands-free HVE suction device 401 with a lip attachment feature 402, similar to lip/cheek retractor attachment feature 301, described above, attached to the lip of a patient 404 and the vacuum tube connection point attached to a standard HVE valve 403. FIG. 5 illustrates one embodiment of a hands-free HVE suction device 501, in use, attached to a standard HVE valve 502 and an alternate position on the lip of a patient 503. FIGS. 4 and 5 illustrate exemplary uses of the device of the present invention. Other positions and uses are contemplated within the scope of the present invention.

The below itemized features describe various exemplary features and/or benefits provided by aspects of the present invention. The list below is not a complete list of the features and should not be taken to limit aspects of the present invention in any manner.

Features of the present invention include—
1. A hands-free dental suction device comprising a lip attachment feature and a lip/cheek retractor attachment feature;
2. The hands-free dental suction device of feature 1, wherein the lip/cheek retractor attachment feature is located approximately centrally to the device body along the vertical axis;
3. The hands-free dental suction device of feature 1, wherein the lip/cheek retractor attachment feature is comprised of two distinct attachment features located laterally with respect to the device body;
4. The hands-free dental suction device of feature 1, wherein the lip/cheek retractor attachment features of feature 2 and feature 3 are both present in the device;
5. The hands-free dental suction device of feature 2, wherein the lip/cheek retractor attachment feature is oriented approximately normal to the suction opening of the device;
6. The hands-free dental suction device of feature 3, wherein the lip/cheek retractor attachment features are oriented approximately normal to the suction opening of the device;
7. The hands-free dental suction device of feature 4 wherein the retractor attachment features are capable of being used in combination with one another;
8. The hands-free dental suction device of feature 1, wherein the lip attachment feature is located approximately centrally to the device body along the vertical axis; and
9. The method of feature 8 wherein the lip attachment feature is oriented approximately normal to the suction opening of the device.

Terminology

The terms “or” and “and/or” as used herein are to be interpreted as inclusive or meaning any one or any combination. As an example, “A, B, or C” or “A, B, and/or C” mean “any of the following: A; B; C; A and B; A and C; A, B, and C.” An exception to this definition will occur only when a combination of elements, functions, steps, or acts are in some way inherently mutually exclusive.

As this invention is susceptible to embodiments of many different forms, it is intended that the present disclosure is to be considered as an example of the principles of the invention and not intended to limit the invention to the specific embodiments shown and described. Any embodiment described may be combined with any other embodiment described unless combinations of elements, functions, steps, or acts are in some way inherently mutually exclusive.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a sub combination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. A hands-free dental suction device comprising:
a suction body extending from a distal end to a proximal end thereof;
a lip attachment feature disposed on one side of the suction body adjacent the proximal end; and
a lip/cheek retractor attachment feature disposed on one side of the suction body.

2. The hands-free dental suction device of claim 1, wherein the lip/cheek retractor attachment feature is located approximately centrally along the suction body along a longitudinal axis thereof.

3. The hands-free dental suction device of claim 1, wherein the lip/cheek retractor attachment feature includes two lip/cheek retractor attachment features located along a longitudinal axis of the suction body.

4. The hands-free dental suction device of claim 3, wherein the two lip/cheek retractor attachment features are disposed centrally along the suction body.

5. The hands-free dental suction device of claim 1, wherein the lip/cheek retractor attachment feature provides a path for a lip/cheek retractor to extend therethrough that is oriented approximately normal to the suction body.

6. The hand-free dental suction device of claim 1, wherein the proximal end has a suction opening formed therein.

7. The hand-free dental suction device of claim 1, wherein the suction opening has a mouth opening that is wider than a width of a flow path through the suction body.

8. The hand-free dental suction device of claim 1, wherein the suction opening has a mouth opening that is narrower than a width of a flow path through the suction body.

9. The hands-free dental suction device of claim 1, wherein a distal end of the suction body includes a suction tube connection point.

10. The hand-free dental suction device of claim 1, wherein the suction body includes:
a first portion extending between the proximal end to a first bend in the suction body; and
a second bend in the suction body prior to the distal end thereof.

11. The hand-free dental suction device of claim 10, wherein the first bend is in a first direction toward a back side of the suction body and the second bend is in a second direction, opposite the first direction.

12. The hand-free dental suction device of claim 11, wherein the first bend and the second bend provide a jog along the length in the suction body.

13. The hands-free dental suction device of claim 1, wherein:
the lip attachment feature is disposed on a back side of the suction body; and
the lip/cheek retractor attachment feature is disposed on the back side of the suction body.

14. A hands-free dental suction device comprising:
a suction body extending from a distal end to a proximal end thereof;
a suction opening formed at the proximal end;
a suction tube connection point at the distal end;
a lip attachment feature disposed on a back side of the suction body adjacent the proximal end; and
a lip/cheek retractor attachment feature disposed on the back side of the suction body, wherein
the lip/cheek retractor attachment feature provides a path for a lip/cheek retractor to extend therethrough that is oriented approximately normal to the suction body.

15. The hands-free dental suction device of claim 14, wherein the lip/cheek retractor attachment feature is located approximately centrally along the suction body along a longitudinal axis thereof.

16. The hand-free dental suction device of claim 14, wherein the suction opening has a mouth opening that is wider than a width of a flow path through the suction body.

17. The hand-free dental suction device of claim 14, wherein the suction opening has a mouth opening that is narrower than a width of a flow path through the suction body.

18. A hands-free dental suction device comprising:
a suction body extending from a distal end to a proximal end thereof;
a suction opening formed at the proximal end;
a suction tube connection point at the distal end;
a lip attachment feature disposed on a back side of the suction body adjacent the proximal end; and
a lip/cheek retractor attachment feature disposed on the back side of the suction body, wherein
the suction body includes a first portion extending between the proximal end to a first bend in the suction body and a second bend in the suction body prior to the distal end thereof.

19. The hand-free dental suction device of claim 18, wherein the first bend is in a first direction toward a back side of the suction body and the second bend is in a second direction, opposite the first direction.

20. The hand-free dental suction device of claim 18, wherein the suction opening has a mouth opening configured for either a high volume flow therethrough or a high velocity flow therethrough.
